(19) United States
(12) Patent Application Publication
(10) Pub. No.: US 2024/0031770 A1
(43) Pub. Date: Jan. 25, 2024

(54) DETERMINING WIRELESS DEPLOYMENT TYPE FOR OPTIMIZED SPECTRUM UTILIZATION

(71) Applicant: Cisco Technology, Inc., San Jose, CA (US)

(72) Inventors: Peiman AMINI, Fremont, CA (US); Vishal S. DESAI, San Jose, CA (US); Ardalan ALIZADEH, Milpitas, CA (US); Sudhir K. JAIN, Fremont, CA (US)

(21) Appl. No.: 17/813,840

(22) Filed: Jul. 20, 2022

(51) Int. Cl. H04W 4/02; H04W 4/33; H04L 41/0893

(52) U.S. Cl. CPC H04W 4/023; H04W 4/33; H04L 41/0893; H04W 88/10

(57) ABSTRACT

Techniques for automated wireless deployment configuration are provided. Environmental sensor data from a plurality of access points (APs) is received, and the plurality of APs are clustered into a set of clusters based on the environmental sensor data. Cluster classifications are generated by classifying each cluster in the set of clusters as either an indoor cluster or an outdoor cluster based on the environmental sensor data and one or more defined environmental values. A respective label is assigned to each respective AP in the plurality of APs based on the cluster classifications, and one or more of the plurality of APs are reconfigured based on the assigned labels.

### TECHNICAL FIELD

Embodiments presented in this disclosure generally relate to wireless networks. More specifically, embodiments disclosed herein relate to automated classification of wireless deployments based on deployment type.

### BACKGROUND

Wireless networks are generally created using broadcasting devices (e.g., access points (APs)) to provide the network connectivity, enabling interconnectivity among devices (e.g., client devices such as smartphones) on the network and/or to other networks (e.g., via the Internet). There are a wide variety of devices and wireless spectrums that can be used, such as 2.4 GHz, 6 GHz, and the like. At times, a given band of the spectrum may be used by multiple networks in parallel, which can result in contention and interference. In some cases, use of the spectrum is controlled by various regulatory bodies (such as the Federal Communications Commission (FCC)) in order to prevent or reduce such contention. For example, there are often incumbent carriers using the 6 GHz band for cellular networks, as well as some systems using the 6 GHz band for Wi-Fi networks. In some systems, Wi-Fi APs are carefully controlled to prevent or reduce contention between the networks. However, conventional systems generally require self-reporting and control of the APs, which can allow for mistakes, malicious actions, and other errors that can cause increased spectrum contention and interference.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for classifying and configuring wireless deployments.

FIG. 2 depicts an example workflow for automated deployment classification and configuration based on environmental sensor data.

FIG. 3 is an example chart depicting automated deployment classification based on environmental sensor data.

FIG. 4 is a flow diagram depicting an example method for wireless deployment classification and configuration based on environmental sensor data.

FIG. 5 is a flow diagram depicting an example method for classifying clusters based on environmental sensor data.

FIG. 6 is a flow diagram depicting an example method for scoring clusters for improved classification based on environmental sensor data.

FIG. 7 is a flow diagram depicting an example method for configuring wireless APs based on environmental sensor data.

FIG. 8 depicts an example computing device configured to perform various aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, comprising: receiving environmental sensor data from a plurality of access points (APs); clustering the plurality of APs into a set of clusters based on the environmental sensor data; generating cluster classifications by classifying each cluster in the set of clusters as either an indoor cluster or an outdoor cluster based on the environmental sensor data and one or more defined environmental values; assigning a respective label to each respective AP in the plurality of APs based on the cluster classifications; and reconfiguring one or more of the plurality of APs based on the assigned labels.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### Example Embodiments

Aspects of the present disclosure provide improved wireless networking via deployment classification and configuration based on environmental data. In some embodiments, the deployment type of a given AP can be classified as an indoor deployment or an outdoor deployment, and the transmission parameters of the AP (e.g., the power level, the frequencies used, whether interfacing with an automated frequency coordination (AFC) server is required, and the like) can be configured based on this classification. In some embodiments, APs in a network can collect and report various environmental data, such as volatile organic compounds (VOCs) and carbon dioxide (CO₂) levels, to a central system. This system can then use the environmental data to cluster and/or classify the APs based on whether they are deployed indoors or outdoors. These classifications can then be used to provide appropriate configuration and control of the APs.

In some embodiments, APs may use various levels of transmission power based at least in part on whether they are deployed indoors or outdoors. For example, FCC regulations or industry practice may allow for standard power operations (e.g., for licensed operators or those that comply with AFC requirements), as well as low-power operations (e.g., for unlicensed operators or those that do not use AFC). For instance, an AP may use standard power for outdoor deployments, provided that the AP uses AFC to coordinate the usage with others so as to avoid or reduce interference with incumbent networks (e.g., cellular networks). Similarly, indoor APs may use low power operation and not require or use AFC (e.g., because the signal will generally attenuate due to the interior deployment before it can interfere with incumbent networks).

In some embodiments, standard power unlicensed APs, before beginning operations in designated bands (e.g., U-NII-5 and U-NII-7), contact an AFC system to obtain a list of permissible frequencies for operations. To facilitate the computation of this list of permissible frequencies, in some aspects, the AP provides its location, antenna height, and/or uncertainty of its location (i.e., accuracy in meters). Additionally, in some aspects, low-power indoor (LPI) mode is allowed, because channel loss measurements show that building entry attenuation is large enough (e.g., −20 dB) to allow APs transmit at the lower power (e.g., 30 dB) in any band with no AFC inquiry.

In some embodiments, standard-power operations encompass standard-power APs and fixed client devices, and are permitted in the 5.925-6.425 GHz and 6.525-6.875 GHz portions of the 6 GHz band, so long as they operate under the control of an AFC system to prevent harmful interference to microwave links that operate in the band. In addition low-power indoor APs (e.g., 5 dBm/MHz) and clients (e.g., −1 dBm/MHz) are permitted operate throughout the 6 GHz bands without contacting the AFC system as long as these devices are confined to indoor environments.

However, conventional systems require that the AP and/or deployment (e.g., a controller for the network) self-report the deployment type/state (e.g., based on the defined type or model of the AP). For example, APs designed or intended for outdoor use may be weather resistant, use external antenna, and/or be battery powered, while APs designed for internal use may lack such features. Generally, each AP reports its deployment type based on its configuration (e.g., where a user or administrator specifies whether the AP is indoors or outdoors). In the absence of such manual configuration, the APs often rely on their default setting (defined based on their design or intended use).

This can result in significant inefficiencies and/or interference. For example, even though the form factor of indoor and outdoor APs often differ and each has often been designed for certain deployments, users frequently use APs in unmatched environments. For example, although indoor units are generally not weather resistant, use integrated antennas rather than connecting external antennas, and generally do not use battery power, it is common for users to install them outdoors (e.g., under covered areas such as porches or overhangs, or within weather resistant enclosures). Similarly, it is common for users to deploy outdoor APs in indoor environments, such as within greenhouses or other plant-growing facilities, in order to ensure they are protected from moisture and humidity.

This inappropriate usage can drastically influence the deployment of AFC-enabled and non-AFC-enabled APs, causing non-optimal power usage and/or interference to microwave links that exceeds expected or regulated levels. For example, if an indoor AP is deployed outside with AFC support, the outdoor-installed (but indoor type) AP will report, to the AFC server, that it is indoors. In response, the AFC server may allow standard and/or low-power operations to due to the expected building entry loss, even though such attenuation is not actually present.

Similarly, an indoor AP may be deployed outdoors without any AFC support. In such a case, the outdoor-installed AP will operate in LPI mode in the entire band, which is generally not allowed or desired for outdoor use as it can significantly impact the incumbent system(s). Additionally, outdoor APs may be deployed indoors. In such a case, the indoor-installed AP will report its deployment as outdoors to the AFC system, and the AFC may disallow standard power in channels that can be used indoors, or even disallow LPI operation, which does not need AFC permission when used indoors, due to the incorrect deployment reporting.

In an embodiment, the AP(s) in a deployment can use a variety of environmental sensors (which may be included with or attachable to the AP to enable air quality monitoring in residential and commercial buildings) to collect environmental data about their location. The specific sensors and environmental data collected may vary depending on the particular implementation, but may include aspects such as temperature sensors, relative humidity sensors, gas sensors (e.g., to detect total VOCs (TVOCs), estimate carbon dioxide, and generally monitor indoor air quality), air pressure sensors, and the like. By evaluating this environmental data, the system can classify the APs as existing indoors or outdoors, and configure them accordingly.

For example, in some embodiments, VOC measurements are used to classify the APs as indoors or outdoors. VOCs are emitted as gases from certain solids or liquids. Many VOCs are human-made chemicals that are used and produced in the manufacture of paints, pharmaceuticals, refrigerants, and the like. VOCs are also often used in industrial solvents, such as trichloroethylene, fuel oxygenates (such as methyl tert-butyl ether (MTBE)), or exist as by-products produced by chlorination in water treatment, such as in the case of chloroform. VOCs are also often components of petroleum fuels, hydraulic fluids, paint thinners, and dry cleaning agents, and are common ground-water contaminants.

VOC concentrations are a function of both outdoor sources (e.g., vehicle exhaust) and indoor sources (e.g., environmental tobacco smoke or consumer products). Generally, levels of many VOCs are typically higher inside buildings as compared to outdoor locations. Indeed, during certain activities, indoor levels of VOCs may reach 1,000 times those of the outside air. Accordingly, in some embodiments, evaluating the reported TVOCs from each AP can allow the system to infer or determine whether each AP is deployed indoors or outdoors.

In some embodiments, carbon dioxide measurements are used to classify the APs as indoors or outdoors. As humans produce and exhale carbon dioxide (CO₂), concentrations of carbon dioxide in occupied indoor spaces are generally higher than concentrations outdoors. Further, as the ventilation rate (e.g., the rate of outdoor air supply to the indoors) per person decreases, the magnitude of the indoor-outdoor disparity in carbon dioxide concentration increases. Typical outdoor carbon dioxide concentrations are approximately 380 parts-per-million (ppm), though outdoor levels in urban areas as high as 500 ppm have been reported. In contrast, concentrations of carbon dioxide inside buildings range from relatively low outdoor levels up to several thousand parts per million. Accordingly, in some embodiments, evaluating the reported carbon dioxide measurements from each AP can allow the system to infer or determine whether each AP is deployed indoors or outdoors.

In some embodiments, temperature measurements are used to classify the APs as indoors or outdoors. For example, indoor APs may be deployed in buildings and offices which are equipped with well-controlled heating, ventilation, and air conditioning (HVAC). Therefore, the daily temperature changes will be relatively small for an indoor environment, as compared to an outdoor environment. Similarly, in indoor environments there are often short-term (high frequency) changes in temperature due to on and off switching of the HVAC system, while outdoor temperature changes are generally smooth and low-frequency. Accordingly, in some embodiments, evaluating the reported temperature measurements from each AP can allow the system to infer or determine whether each AP is deployed indoors or outdoors.

In some embodiments, air pressure measurements can similarly be used to classify the APs as indoors or outdoors. For example, high-frequency air pressure changes (e.g., as the HVAC system cycles on and off) may be detected for indoor deployments, while outdoor deployments see smoother (or low frequency) air pressure changes. Accordingly, in some embodiments, evaluating the reported air pressure measurements from each AP can allow the system to infer or determine whether each AP is deployed indoors or outdoors.

Additionally, in some aspects, detected humidity may be used, as the detected humidity tends to differ between indoor and outdoor deployments, depending at least in part on the time of day. As additional examples of data that can be used to classify APs, in some embodiments, global navigation satellite systems (GNSS) may be used to provide geo-locating of the devices. In one such embodiment, the GNSS receiver parameters (such as the signal to noise ratio (SNR) and/or the ratio of carrier power to the noise power mixed with the signal), the number of detected satellites, the accuracy of the predicted location (DOP), and the like) can be also combined with the environmental sensor data to improve deployment classification.

As additional non-limiting examples of sensor data that can be used to classify APs based on their deployment type, the system may be configured to collect and evaluate data such as illuminance/light level at each AP, sound levels (e.g., background noise levels), measurements of air pollution particles (e.g., PM_{2.5} and/or PM₁₀ particles), carbon monoxide (CO) measurements, oxygen measurements, ozone measurements, infrared and/or mmWave radar measurements (e.g., to detect movements in the space surrounding each AP and/or the shape(s) of the surroundings), and the like.

In some embodiments, the system can use one or more clustering techniques (e.g., k-means clustering) to cluster the APs based on their reported environmental data, and classify each cluster based on their centroids, as discussed in more detail below. The system can then reconfigure the APs appropriately based on the classifications (e.g., labeling indoor-deployed APs as indoors, and outdoor-deployed APs as outdoors, regardless of the default or current tag each has).

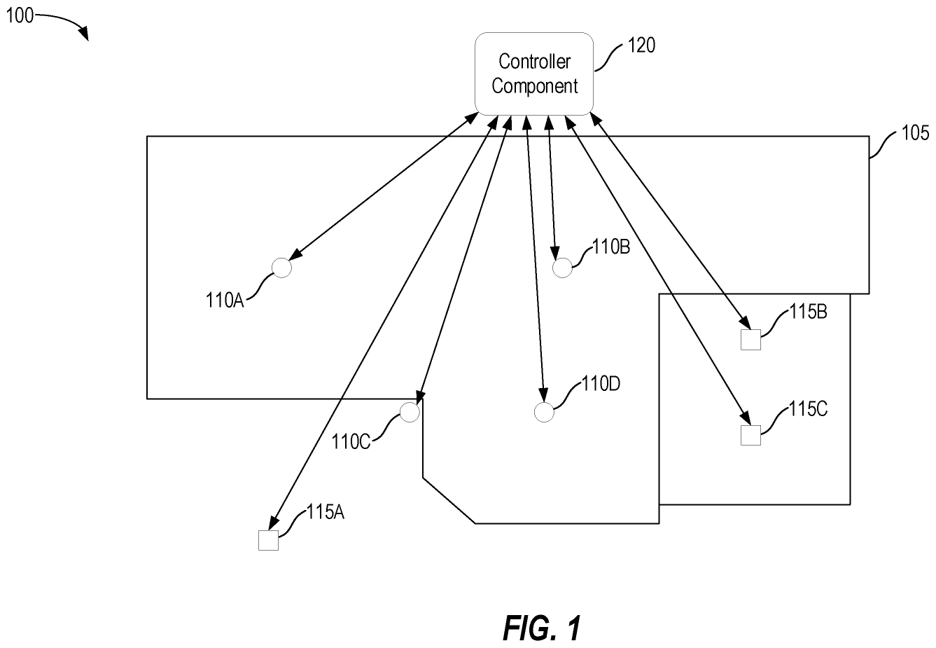

FIG. 1 depicts an example environment 100 for classifying and configuring wireless deployments.

In the illustrated example, a controller component 120 manages a set of APs 110 and 115 deployed in a physical space 105. The space 105 may correspond to a building and/or surrounding area. For example, the space 105 may be hardware store, including the indoor area(s) (e.g., where power tools are stored and sold), indoor gardening area(s) (e.g., greenhouses where plants are stored and sold), and outdoor area(s) (e.g., parking lots, outdoor garden areas, and the like).

The APs 110 and 115 generally correspond to any wireless network access point, such as Wi-Fi access points. In at least one embodiment, the APs 110 and 115 operate in the 6 GHz band. As discussed above, various regulations or guidelines may apply to such deployments, including that APs deployed outdoors must interface with an AFC system to prevent interference, and APs deployed indoors can use a lower transmission power without interfacing with the AFC system.

As illustrated, the APs 110 and 115 are deployed in various locations in the space 105. In the illustrated example, indoor APs 110 (e.g., those having the design or form factor of an indoor device, such as lack of weather resistance) are depicted as circles, while outdoor APs 115 (e.g., those having the design or form factor of an outdoor device, such as weather resistance) are depicted as squares. As discussed above, an AP may be considered an “indoor” AP or “outdoor” AP based on its design, brand and/or model, default configuration, and the like. For example, outdoor APs 115 may be weather resistant, while indoor APs 110 are not. In an embodiment, this deployment type label or tag can be stored in the configuration of the AP.

In the illustrated example, the APs 110A, 110B, 110D, 115B, and 115C are actually deployed indoors. For example, APs 110A, 110B, and 110D may be deployed in the general indoor area of the space 105, while the APs 115B and 115C are deployed in a greenhouse or gardening area. That is, although the APs 115B and 115C are designed or designated as outdoor APs, they are actually deployed indoors (e.g., due to concern about high humidity or moisture in the greenhouse). Similarly, APs 110C and 115A are deployed outdoors. For example, AP 115A may be deployed in the parking area, while AP 110C is located near an entrance (e.g., under a shelter or overhang at the entrance to the store). That is, although the AP 110C is designed or designated as an indoor AP, it is deployed outdoors.

As discussed above, this deployment mismatch (where indoor AP 110C is deployed outdoors and outdoor APs 115B and 115C are deployed outdoors) can result in significant inefficiencies in the network itself, as well as increased wireless interference to incumbent networks.

In the illustrated example, therefore, the controller component 120 can receive environmental data from the APs 110 and 115, and use this data to classify each AP 110 and 115 based on whether it is deployed indoors or outdoors. The controller component 120 may generally be implemented as a discrete system and/or integrated into another system, and may be implemented using hardware, software, or a combination of hardware and software. For example, in at least one embodiment, the controller component 120 is part of a controller that manages the wireless deployment.

As discussed above, the environmental data can include a wide variety of information, such as temperature data, air pressure data, TVOC data, carbon dioxide data, and the like. In some embodiments, as discussed above, the controller component 120 uses clustering to classify the APs 110 and 115. That is, rather than independently labeling each AP based on its environmental sensor data (which may result in inaccurate classifications due to inherent variations between buildings and times), the controller component 120 can use clustering to assign the APs 110 and 115 into clusters based on their reported data, and label these clusters based on their centroids.

While many conventional clustering problems rely on complicated algorithms such as hierarchical clustering to determine how many clusters exist in the data, in some embodiments of the present disclosure, the controller component 120 can simply use two clusters (one for indoor-deployed APs and one for outdoor-deployed APs), thereby reducing computational complexity of the classifying. In some embodiments, the controller component 120 can dynamically handle situations where all APs are deployed in the same environment (e.g., all indoors or all outdoors) using distance thresholds and data scoring, as discussed in more detail below.

In some embodiments, the controller component 120 uses an unsupervised clustering technique, as there is no prior information available about the appropriate label of each cluster. In at least one embodiment, the controller component 120 uses techniques such as k-means clustering, fuzzy k-means, and the like to perform the clustering.

Many conventional unsupervised clustering techniques have significant inefficiencies due to the use of randomly-sampled initial cluster centers. That is, conventional approaches generally instantiate the clusters using random cluster centers, iteratively refining these centers to fit the data. As these initial clusters are randomly-centered, a large number of iterations are often needed to find the accurate cluster centers.

In some embodiments of the present disclosure, the controller component 120 can use historical environmental data to define the initial cluster centers. For example, based on prior observations (from the environment 100 or other environments), the controller component 120 may set one initial cluster center at 400 ppm carbon dioxide and 0.4 mg/m³ TVOCs (e.g., based on historic outdoor environmental data), while a second initial cluster center is set to 700 ppm carbon dioxide and 8 mg/m³ TVOC (e.g., based on historic indoor environmental data). This can allow the controller component 120 to more rapidly find the accurate cluster centers, thereby reducing the latency of the operation and reducing the computational expense (e.g., through reduced clustering iterations). In an embodiment, the initial cluster centers, based on prior environmental data, may be defined manually and/or automatically, and may be defined based on data specific to the environment 100 or across a variety of environments (e.g., by a central entity that provides the APs to multiple customers).

In some embodiments, after finding the centers of the clusters (e.g., using k-means) and assigning each AP 110 and 115 to a cluster (e.g., by assigning each AP to its nearest cluster based on the reported environmental data and the determined cluster centers), the controller component 120 can evaluate the cluster centers to determine which is outdoors and which is indoors. In at least one embodiment, to do so, the controller component 120 can use a rules-based method based on prior knowledge about the environmental metrics (e.g., general TVOC measurements indoors versus outdoors). For example, the controller component 120 may determine statistics of the data, such as the average value and/or variance value of TVOC measurements and carbon dioxide measurements for each cluster (e.g., the average and/or variance of the values reported by the APs included in each cluster). As both the average and variance may generally be larger for indoor settings, the controller component 120 can identify which cluster center has a larger average value and/or variance value for these metrics, and thereby classify this cluster as indoors (and the other cluster as outdoors).

In at least one embodiment, the controller component 120 can identify when all the APs are deployed in a single group (e.g., all indoors or all outdoors) by determining and evaluating the distance between the cluster centers. In one such embodiment, if the distance meets specified criteria (e.g., less than or equal to a defined minimum threshold), the controller component 120 can determine that the entire network is likely deployed in either indoor or outdoor conditions. In some embodiments, the controller component 120 can therefore merge the clusters and use a rules-based method and/or scoring approach based on prior knowledge about the metrics. For example, the controller component 120 may score each AP's metrics (or the average metrics across all APs in the deployment) based on min-max normalized metrics (with optional weighting for each value). For example, for the i-th metric m (e.g., temperature data, TVOC data, and the like), the controller component 120 may compute a sub-score sᵢ as

$${w}_{i} \frac{{m}_{average} - {m}_{minimum}}{{m}_{maximum} - {m}_{minimum}} ,$$

where wᵢ is the weight of the metric, and m_{average}, mₘᵢₙᵢₘᵤₘ, and mₘₐₓᵢₘᵤₘ are the average, minimum, and maximum values of the metric, respectively, as reported by the individual AP or the group of APs. These sub-scores can then be aggregated (e.g., using summation) to generate an overall score for the AP and/or deployment.

In one embodiment, the larger the score, the higher the probability that the AP(s) is deployed in an indoor environment. Therefore, the controller component 120 may use one or more defined thresholds to classify the APs. For example, the controller component 120 may label any APs with a score less than or equal to 1 as outdoor deployments, and APs with a score greater than 1 as an indoor deployment. In at least one embodiment, the controller component 120 may use two thresholds. For example, APs with a score below the first threshold (e.g., 1) may be classified as outdoor, while APs with a score above a second threshold (e.g., 2) may be classified as indoor. In one such embodiment, for any APs falling within the defined range (e.g., between 1 and 2), the controller component 120 may determine that their deployment state is unknown. In some embodiments, the controller component 120 can use the default configuration (e.g., determined based on the model number or stock keeping unit (SKU) of the AP) as the label for the unknown AP(s).

In some embodiments, based on these classifications, the controller component 120 can reconfigure the APs 110 and 115 as needed (e.g., to label the AP 110C as deployed outdoors, and the APs 115B and 115C as deployed indoors). In this way, the controller component 120 can improve the functioning of the local network (e.g., allowing each AP 110 and 115 to use the best operational settings, such as power settings and permissible frequencies, and/or enabling appropriate interaction with the AFC system). This can improve the strength of the network (e.g., the perceived signal strength at various points in the area), as well as the bandwidth/throughput and stability in the network. Further, this improves the functioning of other networks (e.g., incumbent networks such as cellular networks) by reducing or eliminating interference with such networks.

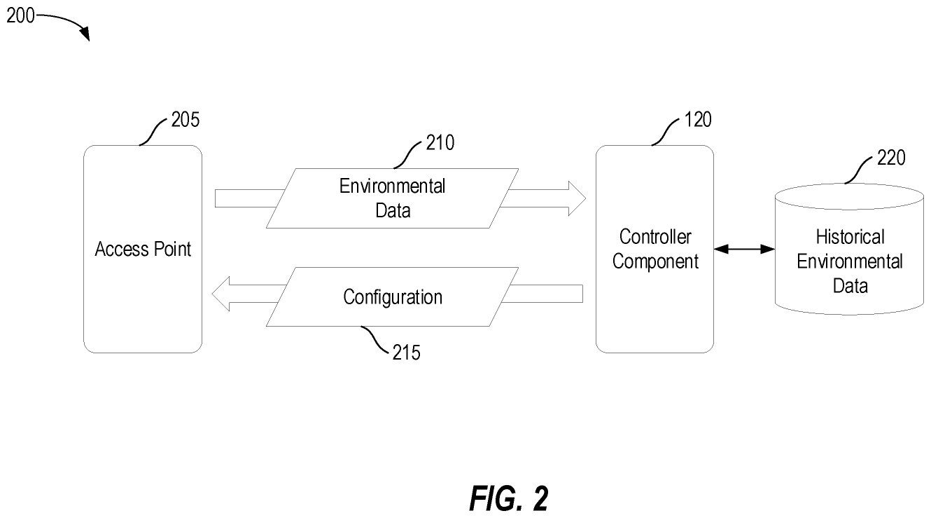

FIG. 2 depicts an example workflow 200 for automated deployment classification and configuration based on environmental sensor data.

In the illustrated example, an access point 205 is communicatively coupled with a controller component 120. Although a single access point 205 is depicted for conceptual clarity, in embodiments, there may be any number of APs 205. The AP 205 and controller component 120 may be communicatively linked using any suitable technologies. This link may include one or more wired connections, one or more wireless connections, and the like.

In the illustrated example, the AP 205 collects and transmits environmental data 210 to the controller component 120, as discussed above. For example, the environmental data 210 may include the detected temperature, air pressure, TVOC measurements, carbon dioxide concentration, and the like. In some embodiments, the AP 205 transmits the environmental data 210 periodically, such as hourly, daily, and the like. In at least one aspect, the controller component 120 can collect the environmental data 210 over time, and evaluates environmental data spanning a window of time (e.g., reported every five minutes throughout a twenty-four hour period) to classify the AP 205.

For example, as discussed above, the controller component 120 may determine the average temperature reported by the AP 205 during the day, the temperature range (e.g., the difference between the minimum and maximum reported values), the variance or standard deviation of the reported values, the change or peak-to-peak frequency (e.g., the time between adjacent peaks in the data, such as whether there are frequent peaks in the value when plotted over time, indicating frequent temperature swings and suggesting presence of an HVAC system), and the like.

In an embodiment, the controller component 120 can use the environmental data 210 from the AP 205 (and any other APs in the deployment/being considered) to cluster the APs 205, as discussed above. In the illustrated embodiment, the controller component 120 can then use the historical environmental data 220 to label or classify each AP/cluster. For example, as discussed above, the controller component 120 may find the cluster having a higher TVOC and/or carbon dioxide value, and label the corresponding APs as indoor-deployments. In some embodiments, as discussed above, the controller component 120 can additionally or alternatively compute a score for each AP (or for the group of APs), and label them based on comparing the score to one or more thresholds defined based on historical environmental data 220.

As illustrated, after classifying the AP 205, the controller component 120 can return an appropriate configuration 215. In an embodiment, the controller component 120 may refrain from transmitting the configuration 215 if the current configuration of the AP 205 matches the determined deployment type. For example, if the AP 205 is already configured as an indoor AP and the controller component 120 classifies it as an indoor deployment, the controller component 120 may refrain from transmitting an updated configuration 215 (as one is not needed).

As discussed above, the configuration 215 generally labels the AP 205 as an indoor or outdoor deployment. Based on this label, the controller component 120 and/or AP 205 can take a variety of actions. For example, if the AP 205 is configured to interact with an AFC system, upon receiving a configuration 215 indicating that it is an outdoor AP, the AP 205 may begin that interaction in order to comply with regulations and prevent interference. Similarly, if the configuration 215 indicates that the AP 205 is deployed indoors, the controller component 120 may begin using LPI mode for its operations.

In some embodiments, the workflow 200 may be repeated any number of times and with any frequency. For example, the controller component 120 may perform the clustering and reconfiguration periodically (e.g., weekly), or may do so once or upon instruction from an administrator (e.g., when the deployment is first installed). Similarly, the controller component 120 may perform the process upon the occurrence of specified criteria, such as whenever a new AP is added to the network, whenever the reported environmental data 210 changes more than a defined amount, when an AP comes back online after a period of being offline (e.g., indicating that it may have been moved to a new area), and the like.

As discussed above, by enabling more accurate deployment classifications, the workflow 200 can generally improve the functionality of the AP 205 and the local network, as well as the operations and functionality of any other networks in the physical space.

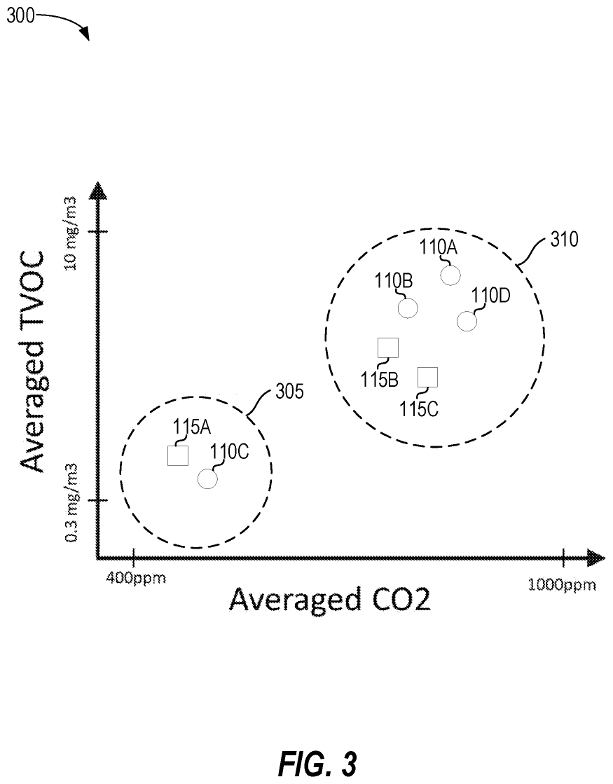

FIG. 3 is an example chart 300 depicting automated deployment classification based on environmental sensor data.

In the illustrated example, the chart 300 graphs environmental data on two dimensions: the average TVOC reported by each AP (e.g., averaged throughout a defined period, such as a single day) and the average CO₂ reported by each AP (e.g., averaged throughout a day). Although two dimensions (e.g., two environmental metrics) are depicted for conceptual clarity, in embodiments, there may be any number of metrics and corresponding dimensions. In some embodiments, the system can generally use any statistical data, such as the average value of a metric, the standard deviation or variance of a metric, and the like. For example, as discussed above, the controller component may graph the average TVOC measurement, standard deviation of the TVOC measurements, average carbon dioxide measurement, standard deviation of the carbon dioxide measurements, the average peak-to-peak value of the temperature (e.g., the average time between adjacent peaks and/or troughs in the temperature data, if graphed over time), the range of the temperature measurements (e.g., the distance between the minimum and maximum values during the day), and the like.

In some embodiments, as discussed above, the controller component may use historical environmental data to help facilitate the clustering process. For example, the controller component may instantiate the cluster centers based on average values from other days or environments (or from a fixed configuration that was defined based on historical data), and may use a set of two clusters (rather than attempting to learn how many clusters are needed).

In the illustrated example, based on the environmental data reported by each AP, the controller component has clustered the APs 115A and 110C into a first cluster 305, and clustered the APs 110A, 110B, 110D, 115B, and 115C into a second cluster 310. As discussed above, each AP 110 and 115 is generally assigned to a cluster based on the distance between its environmental data and the cluster centers in the feature space. That is, as the data from the APs 115A and 110C are closer to the center of the cluster 305 than the cluster 310, the APs 115A and 110C are assigned to the cluster 305.

In some embodiments, as discussed above, the controller component can evaluate the cluster centers against a defined minimum distance in order to determine whether the APs are all deployed in a single environment (e.g., all indoors or all outdoors), or if the environmental data otherwise does not differ substantially enough to accurately classify an AP as indoors or outdoors. If so, as discussed above, the controller component may compute a score for each AP (or collectively for the group of APs) to classify them.

In the illustrated example, the controller component may compare the centers of the clusters 305 and 310 against defined thresholds or rules in order to label them. For example, based on a rule indicating that the cluster having a higher average TVOC and higher average carbon dioxide value is the indoor cluster, the controller component may label the cluster 310 and the corresponding APs 110A, 110B, 110D, 115B, and 115C as indoor deployments. The cluster 305 is therefore the outdoor cluster, and the controller component may label the APs 115A and 110C as deployed outdoors.

As a few non-limiting examples, the controller component may use a set of one or more rules specifying that the indoor cluster has a larger value for the averaged TVOCs, a large value for the standard deviation of the TVOCs, a larger value for the average carbon dioxide concentrations, a larger value for the standard deviation of the carbon dioxide concentrations, a larger value for the temperature change frequency, a larger value for the air pressure change frequency, a lower value for the peak-to-peak temperature measurements, a lower value for the range of temperature measurements, and the like. Although the above examples involve specific comparisons with respect to the indoor cluster (e.g., indicating that the cluster having the larger average TVOC value is likely to be the indoor cluster), each rule may of course be specified in other ways (e.g., indicating that the cluster having the smaller average TVOC value is likely to be the outdoor cluster, or indicating that the cluster having the smaller average TVOC value is unlikely to be the indoor cluster).

In embodiments, there may be any number and variety of rules used to classify the clusters. For example, the controller component may include rules indicating, for each environmental metric, whether the metric value is positively associated with an indoor classification (e.g., where higher values indicate a higher probability that the APs are deployed indoors) or positively associated with an outdoor classification. Of course, the rules may similarly indicate that a metric is negatively associated with a given classification, such that lower values would lead to a conclusion that the cluster belongs to the given classification.

In some embodiments, if any of the rules conflict, the controller component can take a variety of actions to resolve the conflict. For example, suppose one cluster has a higher TVOC value, while the other has a higher carbon dioxide value. In one such embodiment, the controller component can rely on a defined weighting for each rule, where each rule may be weighted based on its predictive power (e.g., where rules relying on metrics that are highly-predictive are assigned higher weights). In some embodiments, the controller component may use the magnitude of the differences. For example, if the first cluster has a slightly lower TVOC measurement (e.g., the clusters have similar TVOC values) but a substantially higher carbon dioxide measurement, the controller component may infer that the cluster is an indoor cluster (e.g., by ignoring the TVOC rule). In at least one embodiment, the controller component may take other action, such as flagging the conflict for manual review, or deferring to the default or existing configuration of each AP.

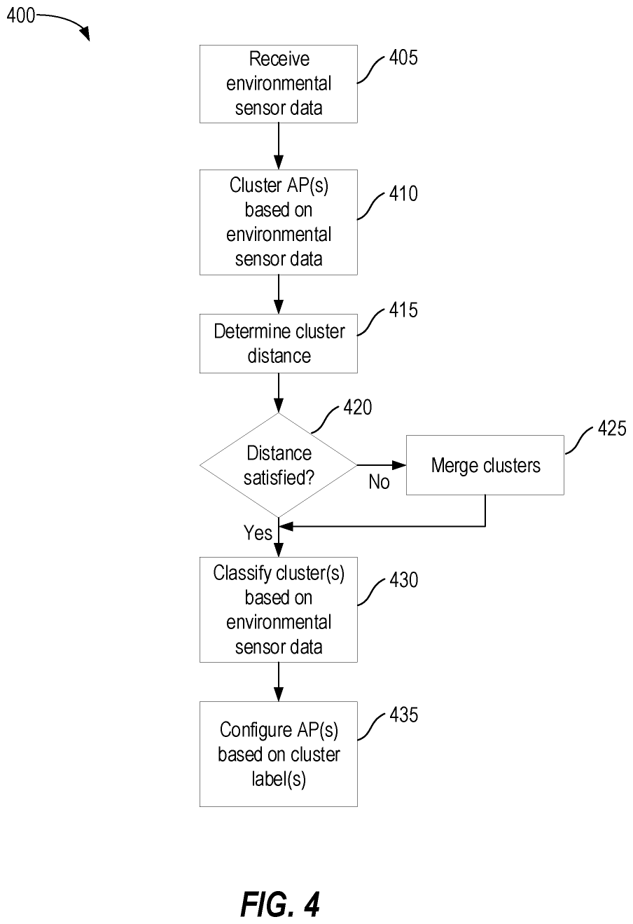

FIG. 4 is a flow diagram depicting an example method 400 for wireless deployment classification and configuration based on environmental sensor data. In some embodiments, the method 400 is performed by a controller component, such as the controller component 120 of FIG. 1 and/or FIG. 2.

At block 405, the controller component receives environmental sensor data (e.g., environmental data 210 of FIG. 2) from one or more APs (e.g., APs 110 and/or 115 of FIG. 1, and/or AP 205 of FIG. 2). As discussed above, the environmental sensor data generally corresponds to data collected via one or more sensors integrated within or otherwise attached to or associated with each AP in order to collect environmental information from the location where the AP is installed or deployed. The environmental sensors data can generally include a wide variety of metrics, such as air pressure, ambient temperature, TVOC measurements, carbon dioxide measurements, and the like.

In some embodiments, the AP(s) and/or controller component may perform various preprocessing on the environmental data. For example, the controller component may aggregate the data collected throughout the course of the day (or other period of time) to determine statistics of the metrics, such as the average reported TVOC and/or carbon dioxide, the peak-to-peak distance for temperature changes, the magnitude of the temperature changes, and the like. These metrics can then be used for downstream processing to cluster the data.

At block 410, the controller component clusters the APs based on the environmental sensor data. In some embodiments, the controller component performs the clustering using an unsupervised clustering technique, such as k-means. In some embodiments, as discussed above, the controller component can perform the clustering technique based in part on known or defined information, such as by using historical environmental data to initialize the cluster centers (thereby reducing the number of iterations needed) and/or fixing or setting the number of clusters to two (e.g., one for indoors and one for outdoors) rather than attempting to learn or infer the appropriate number of clusters.

As discussed above, clustering the APs can generally involve finding or determining appropriate centers for each cluster, based on the environmental data from the APs (e.g., finding specific value(s) for each environmental metric to define the cluster center). In some embodiments, the controller component can then assign APs to each cluster based on their metrics (e.g., based on determining which cluster center is closest to the data from each AP).

At block 415, the controller component determines the cluster distance. That is, the controller component can determine the distance between the centers of each of a pair of clusters generated in block 410. In some embodiments, if two clusters are generated (as discussed above), the controller component can determine the distance between the two cluster centers. In an embodiment, if more than two clusters are used, the controller component can determine the distances between each pair of clusters. In some embodiments, the distance may be defined using a variety of techniques and operations, such as the Euclidean distance between the cluster centers.

At block 420, the controller component determines whether the determined distance(s) satisfy defined criteria, such as a minimum threshold distance (which may be a user-specified threshold, or may be a learned value). If not (e.g., if the clusters are too close together), the controller component can determine or infer that all of the APs are deployed in the same environment (e.g., all indoors or all outdoors), and the method 400 continues to block 425 where the controller component merges the clusters.

In some aspects, to merge the clusters, the controller component can determine a new cluster center (e.g., by averaging the centers of the two clusters, by averaging the metrics reported by each AP, and/or by performing a new clustering to generate a single cluster rather than two). All APs are assigned to this single cluster. The method 400 then continues to block 430. Returning to block 420, if the controller component determines that the cluster distance satisfies the criteria (e.g., because the centers are sufficiently far apart), the method 400 continues to block 430.

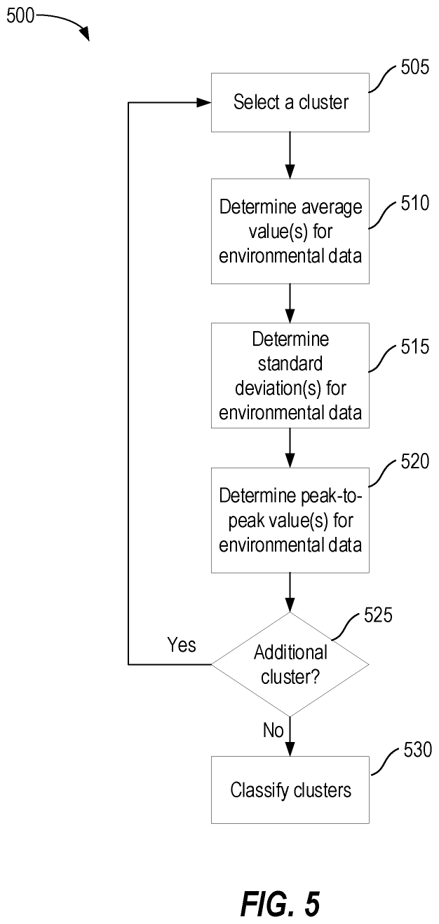

At block 430, the controller component classifies the cluster(s) and AP(s) based on the environmental sensor data reported by the APs. For example, in the case that two or more clusters remain after block 420 (e.g., they are not merged), the controller component can determine a variety of data such as the average TVOCs reported by APs in each cluster, and use a variety of rules (such as specifying that the cluster having a higher average TVOC, or an average TVOC above some threshold, is the indoor cluster) to label the clusters/APs. One example of such a technique is discussed in more detail below with reference to FIG. 5.

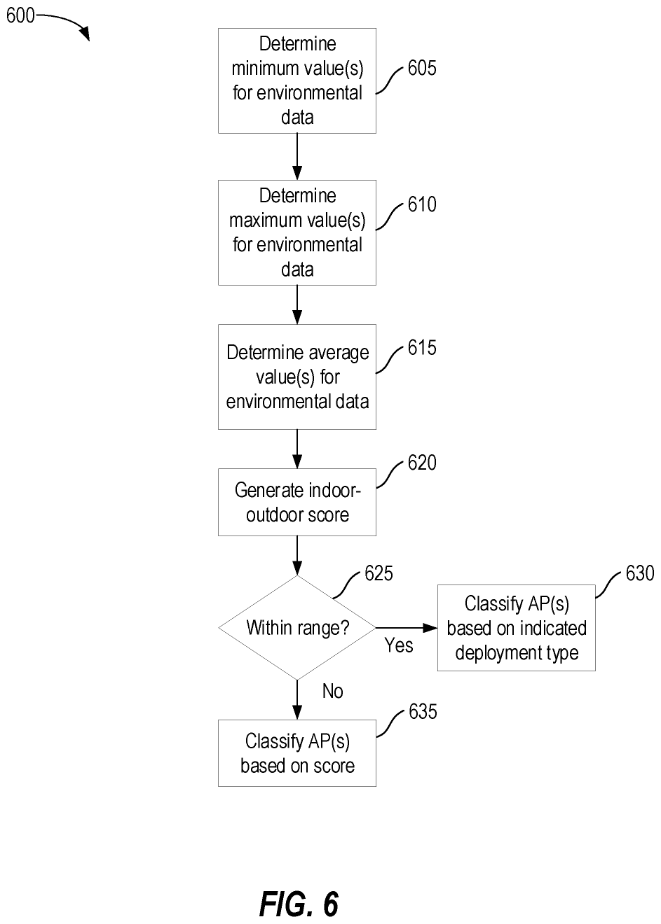

As another example, if a single cluster remains (e.g., the clusters were merged in block 425), the controller component can generate one or more scores for the cluster and/or for each individual AP based on the environmental sensor data. For example, as discussed above, the controller component may score each AP's metrics individually (or score the average metrics across all APs in the cluster or deployment) based on min-max normalized metrics (with optional weighting for each value). The controller component can then classify/label the cluster and/or APs based on comparing the generated score(s) to one or more thresholds, as discussed above. One example of such a technique is discussed in more detail below with reference to FIG. 6.

After classifying the cluster(s) and/or AP(s), the method 400 continues to block 435, where the controller component configures the AP(s) based on the cluster/AP label(s). For example, as discussed above, the controller component may determine, for each AP, whether its current configuration (e.g., the tag or label it uses to indicate whether it is deployed indoors or outdoors) matches with the determined label of the cluster to which the AP belongs. If not, the controller component can reconfigure the AP at least in part by correcting or updating the tag. In some embodiments, as discussed above, the controller component can additionally or alternatively perform other configuration steps, such as instructing the AP to use LPI mode (if the AP is classified as deployed indoors).

FIG. 5 is a flow diagram depicting an example method for classifying clusters based on environmental sensor data. In some embodiments, the method 500 is performed by a controller component, such as the controller component 120 of FIG. 1 and/or FIG. 2. In one embodiment, the method 500 provides additional detail for block 430 of FIG. 4, if there is more than one cluster remaining (e.g., if the two clusters are not merged).

At block 505, the controller component selects one of the generated clusters. Generally, this selection may be performed using any suitable technique and criteria, as all the clusters will be evaluated. Although depicted as a sequential process (e.g., selecting and evaluating each cluster in turn), in embodiments, some or all of the clusters may be evaluated in parallel.

At block 510, the controller component determines average values for one or more metrics in the environmental data, based on the data reported by APs in the selected cluster. For example, as discussed above, the controller component may determine the average TVOC measurement reported by the APs in the cluster throughout the day (e.g., by computing the average of the TVOC measurements reported by the APs in the cluster during the day, in order to generate an overall average TVOC for the cluster), the average carbon dioxide measurements for APs in the cluster, and the like.

At block 515, the controller component determines standard deviations and/or variances for one or more of the metrics in the environmental data, based on the APs in the selected cluster. For example, as discussed above, the controller component may determine the standard deviation of the TVOC measurements from APs in the cluster (e.g., by computing the standard deviation of the individual TVOC measurements reported throughout the day by the APs in the cluster), the standard deviation of the carbon dioxide measurements reported by APs in the cluster, and the like.

At block 1520, the controller component determines the average peak-to-peak value(s) for one or more metrics in the environmental data, based on the APs in the selected cluster. For example, as discussed above, the controller component may determine the peak-to-peak distance between adjacent peaks in the temperature data reported by each AP, and average these peak-to-peak distances to determine an overall (average) peak-to-peak distance value for the temperature changes.

Although not included in the illustrated example, in some embodiments, the controller component can additionally or alternatively determine other values. For example, the controller component may determine the range of one or more metrics (e.g., the difference between the minimum temperature and the maximum temperature reported by each AP, and/or the average of such ranges). In some embodiments, the controller component determines the change frequency of one or more metrics (e.g., the frequency with which the air pressure and/or temperature changes or fluctuates during the day), the humidity changes over the course of the day, and the like.

At block 525, the controller component determines whether there is at least one additional cluster that has not been evaluated. If so, the method 500 returns to block 505. If all clusters have been evaluated, the method 500 continues to block 530.

At block 530, the controller component classifies the clusters based on the determined values. For example, as discussed above, the controller component may use one or more rules that indicate whether a given cluster should be labeled as indoors or outdoors based on the metrics (such as a rule indicating that the cluster having a higher peak-to-peak distance for temperature changes is the outdoor cluster). As discussed above, if any of the rules conflict, the controller component can take a variety of actions to resolve the conflict. For example, the controller component may rely on a defined weighting for each rule, where each rule weight is based on its predictive power (e.g., where rules relying on metrics that are highly-predictive are assigned higher weights). In some embodiments, the controller component may use the magnitude of the differences between the clusters. For example, if one of the conflicting rules indicates that a first cluster is the outdoor cluster but a second rule indicates that the first cluster is the indoor cluster, the controller component may determine how close the values are for each rule, with respect to the other cluster (e.g., whether the relevant metric for a given rule are close for both clusters, or are substantially different between the clusters), and determine which rule(s) should be ignored. In at least one embodiment, the controller component may take other action, such as flagging the conflict for manual review, or deferring to the default or existing configuration of each AP.

As discussed above, using these classifications, the controller component can then configure each AP appropriately based on whether it is deployed indoors or outdoors.

FIG. 6 is a flow diagram depicting an example method for scoring clusters for improved classification based on environmental sensor data. In some embodiments, the method 600 is performed by a controller component, such as the controller component 120 of FIG. 1 and/or FIG. 2. In one embodiment, the method 600 provides additional detail for block 430 of FIG. 4, if there is one cluster remaining (e.g., if the two clusters are merged).

In some embodiments, the method 600 is performed on a per-AP basis. That is, the controller component can compute the various values and an overall indoor-outdoor score for each AP individually based on the environmental data reported by the individual AP. In other embodiments, the method 600 can be performed collectively for all APs in the cluster/deployment (e.g., by computing the various values and overall indoor-outdoor score based on the collective data from all the APs in the cluster).

At block 605, the controller component determines minimum value(s) for one or more metrics in the environmental data. For example, as discussed above, the controller component may determine the minimum TVOC measurement, the minimum carbon dioxide measurement, the minimum temperature measurement, the minimum peak-to-peak temperature distance, and the like. As discussed above, this minimum may be a global minimum across all APs in the cluster throughout the day or other period of time (e.g., to classify the entire cluster together) or a minimum with respect to a single AP throughout the day or other period of time (e.g., to classify the individual AP).

At block 610, the controller component determines maximum value(s) for one or more metrics in the environmental data. For example, as discussed above, the controller component may determine the maximum TVOC measurement, the maximum carbon dioxide measurement, the maximum temperature measurement, the maximum peak-to-peak temperature distance, and the like. As discussed above, this maximum may be a global maximum across all APs in the cluster throughout the day or other period of time (e.g., to classify the entire cluster together) or a maximum with respect to a single AP throughout the day or other period of time (e.g., to classify the individual AP).

At block 605, the controller component determines average value(s) for one or more metrics in the environmental data. For example, as discussed above, the controller component may determine the average TVOC measurement, the average carbon dioxide measurement, the average temperature measurement, the average peak-to-peak temperature distance, and the like. As discussed above, this average may be a global average across all APs in the cluster throughout the day or other period of time (e.g., to classify the entire cluster together) or an average with respect to a single AP throughout the day or other period of time (e.g., to classify the individual AP).

At block 620, the controller component can then generate an indoor-outdoor score for the AP (or set of APs) based on the values determined in blocks 605, 610, and 615. As discussed above, the indoor-outdoor score can generally be a numerical quantity indicating the probability that the AP (or cluster) is deployed indoors (or outdoors). In at least one embodiment, the controller component compute the score based on min-max normalized metrics (with optional weighting for each value). For example, for the i-th metric m (e.g., temperature data, TVOC data, and the like), the controller component 120 may compute a sub-score sᵢ as

$${w}_{i} \frac{{m}_{average} - {m}_{minimum}}{{m}_{maximum} - {m}_{minimum}} ,$$

where wᵢ is the weight of the metric, and m_{average}, mₘᵢₙᵢₘᵤₘ, and mₘₐₓᵢₘᵤₘ are the average, minimum, and maximum values of the metric, respectively, as reported by the AP (or group of APs). These sub-scores can then be aggregated (e.g., using summation) to generate an overall score for the AP and/or cluster.

At block 625, the controller component determines whether the generated indoor-outdoor score is within a defined range. For example, as discussed above, the controller component may use a set of thresholds (e.g., defined manually or learned over time) where scores below a first threshold indicate that the AP or cluster is deployed outdoors, scores above a second threshold indicate that the AP or cluster is deployed indoors, scores in the range between the thresholds indicate uncertainty. In some embodiments, rather than using two or more thresholds, the controller component may use a single threshold (e.g., where scores below the threshold are classified as outdoor and scores above the threshold are classified as indoor).

If the generated score is within the defined range (e.g., between an upper and lower threshold, the controller component may determine that the deployment type of the AP (or cluster) cannot be reliably determined. That is, the controller component cannot ascertain whether the AP (or cluster) is deployed indoors or outdoors, as the environmental data is not conclusively on either side. The method 600 therefore proceeds to block 630, where the controller component classifies the AP (or cluster of APs) based on the deployment type that is currently indicated by the AP or cluster. That is, the controller component can defer to the default configuration (or previously-specified configuration) indicating whether each AP is deployed indoors or outdoors.

If the controller component determines that the score is not within the range (e.g., it is below the lower threshold or above the upper threshold), the method 600 continues to block 635, where the controller component classifies the AP (or cluster of APs) based on the generated score. For example, if the indoor-outdoor score is below the lower bound, the controller component can classify the AP (or cluster) as an outdoor deployment. Similarly, if the indoor-outdoor score is above the upper bound, the controller component can classify the AP (or the cluster) as an indoor deployment.

As discussed above, using these classifications, the controller component can then configure each AP appropriately based on whether it is deployed indoors or outdoors.

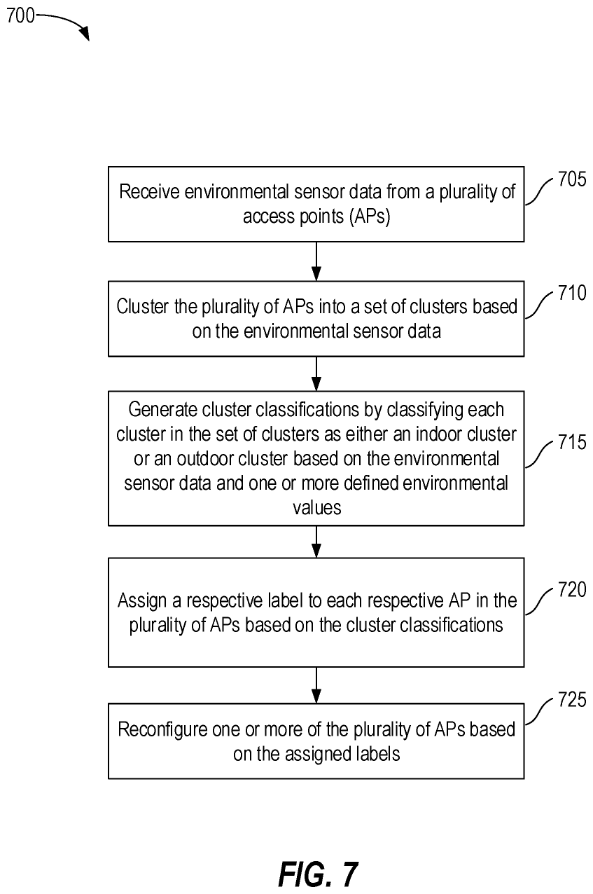

FIG. 7 is a flow diagram depicting an example method for configuring wireless APs based on environmental sensor data. In some embodiments, the method 700 is performed by a controller component, such as the controller component 120 of FIG. 1 and/or FIG. 2.

At block 705, environmental sensor data (e.g., environmental data 210 of FIG. 2) from a plurality of access points (APs) (e.g., AP 205 of FIG. 2) is received.

At block 710, the plurality of APs are clustered into a set of clusters (e.g., clusters 305 and 310 of FIG. 3) based on the environmental sensor data.

At block 715, cluster classifications are generated by classifying each cluster in the set of clusters as either an indoor cluster or an outdoor cluster based on the environmental sensor data and one or more defined environmental values.

At block 720, a respective label is assigned to each respective AP in the plurality of APs based on the cluster classifications.

At block 725, one or more of the plurality of APs are reconfigured (e.g., using configuration 215 of FIG. 2) based on the assigned labels.

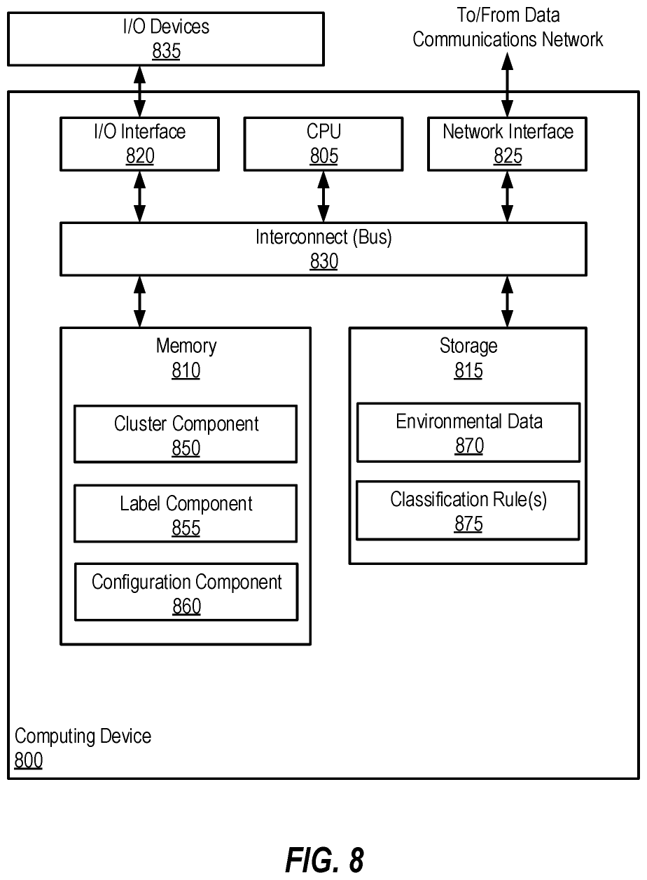

FIG. 8 depicts an example computing device 800 configured to perform various aspects of the present disclosure. Although depicted as a physical device, in embodiments, the computing device 800 may be implemented using virtual device(s), and/or across a number of devices (e.g., in a cloud environment). In one embodiment, the computing device 800 corresponds to the controller component 120 of FIG. 1 and/or FIG. 2.

As illustrated, the computing device 800 includes a CPU 805, memory 810, storage 815, a network interface 825, and one or more I/O interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated embodiment, the memory 810 includes a cluster component 850, a label component 855, and a configuration component 860, which may perform one or more embodiments discussed above. Although depicted as discrete components for conceptual clarity, in embodiments, the operations of the depicted components (and others not illustrated) may be combined or distributed across any number of components. Further, although depicted as software residing in memory 810, in embodiments, the operations of the depicted components (and others not illustrated) may be implemented using hardware, software, or a combination of hardware and software.

In one embodiment, the cluster component 850 is used to cluster the APs based on their reported environmental data, as discussed above. For example, the cluster component 850 may use one or more clustering techniques (e.g., k-means) to assign the APs to clusters. In some embodiments, as discussed above, the clustering component 850 may use defined data (such as the environmental data 870) to initialize or perform the clustering (such as to define initial cluster centers, to define the number of clusters, and the like). The label component 855 may generally be used to label or classify the clusters and/or APs as indoors or outdoors, as discussed above. For example, the label component 855 may use one or more rules to classify the APs/clusters, generate a score for each AP and/or cluster and label them based on the score, and the like. The configuration component 860 may be used to reconfigure the APs as needed, as discussed above. For example, the configuration component 860 may determine, for each AP, whether its current configuration, tag, or label (e.g., as indoor or outdoor) matches the assigned label (e.g., assigned by the label component 855). For any APs having mismatched configurations/labels, the configuration component 860 can deploy a corrected or updated configuration (e.g., to correctly label the AP based on its deployment type).

In the illustrated example, the storage 815 includes a set of environmental data 870. In some embodiments, the environmental data 870 corresponds to historical or prior information, such as data collected over the course of a day (or multiple days), which can be used to perform the clustering and labeling of the APs. In some embodiments, the environmental data 870 includes other prior information, such as defined values to be used as initial cluster centers when clustering, as discussed above.

The storage 815 also includes one or more classification rules 875. In an embodiment, the classification rules 875 may generally indicate how a cluster should be labeled, as compared to the other cluster(s) (e.g., indicating that the cluster having the highest TVOC concentration should be labeled as the indoor cluster). In some embodiments, the classification rules 875 can include one or more threshold values and/or ranges, to be used to classify the AP(s) or cluster(s) based on generated indoor-outdoor scores, as discussed above. Although depicted as residing in storage 815, the environmental data 870 and classification rules 875 may be stored in any suitable location, including memory 810.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving environmental sensor data from a plurality of access points (APs);
clustering the plurality of APs into a set of clusters based on the environmental sensor data;
generating cluster classifications by classifying each cluster in the set of clusters as either an indoor cluster or an outdoor cluster based on the environmental sensor data and one or more defined environmental values;
assigning a respective label to each respective AP in the plurality of APs based on the cluster classifications; and
reconfiguring one or more of the plurality of APs based on the assigned labels.

2. The method of claim 1, wherein clustering the plurality of APs into the set of clusters comprises:
generating a first cluster of APs and a second cluster of APs based on the environmental sensor data; and
in response to determining that a distance between the first cluster and the second cluster is below a defined threshold, merging the clusters.

3. The method of claim 2, wherein assigning a respective label to each respective AP in the plurality of APs further comprises:
determining a minimum value, maximum value, and average value of the environmental sensor data;
computing a respective score for each respective AP in the plurality of APs; and
assigning a respective label to each respective AP based at least in part on the respective score.

4. The method of claim 3, further comprising in response to determining that a first score of a first AP is within a defined range:
determining a deployment type indicated by the first AP; and
assigning a respective label to the first AP based on the indicated deployment type.

5. The method of claim 1, wherein clustering the plurality of APs comprises defining one or more initial cluster centroids based on the one or more defined environmental values.

6. The method of claim 1, wherein:
a first AP of the plurality of APs indicates an indoor deployment type, and
reconfiguring one or more of the plurality of APs comprises configuring the first AP as an outdoor AP.

7. The method of claim 1, wherein the environmental sensor data comprises one or more of:
(i) volatile organic compound (VOC) measurements;
(ii) carbon dioxide measurements; or
(iii) temperature measurements.

8. The method of claim 7, wherein clustering the plurality of APs comprises, determining, for the plurality of APs, one or more of:
a statistic relating to VOC measurements detected by the plurality of APs; or
a statistic relating to carbon dioxide measurements detected by the plurality of APs.

9. A non-transitory computer-readable medium containing computer program code that, when executed by operation of one or more computer processors, performs an operation comprising:
receiving environmental sensor data from a plurality of access points (APs);
clustering the plurality of APs into a set of clusters based on the environmental sensor data;
generating cluster classifications by classifying each cluster in the set of clusters as either an indoor cluster or an outdoor cluster based on the environmental sensor data and one or more defined environmental values;
assigning a respective label to each respective AP in the plurality of APs based on the cluster classifications; and
reconfiguring one or more of the plurality of APs based on the assigned labels.

10. The non-transitory computer-readable medium of claim 9, wherein clustering the plurality of APs into the set of clusters comprises:
generating a first cluster of APs and a second cluster of APs based on the environmental sensor data; and
in response to determining that a distance between the first cluster and the second cluster is below a defined threshold, merging the clusters.

11. The non-transitory computer-readable medium of claim 10, wherein assigning a respective label to each respective AP in the plurality of APs further comprises:
determining a minimum value, maximum value, and average value of the environmental sensor data;
computing a respective score for each respective AP in the plurality of APs; and
assigning a respective label to each respective AP based at least in part on the respective score.

12. The non-transitory computer-readable medium of claim 11, the operation further comprising in response to determining that a first score of a first AP is within a defined range:
determining a deployment type indicated by the first AP; and
assigning a respective label to the first AP based on the indicated deployment type.

13. The non-transitory computer-readable medium of claim 9, wherein clustering the plurality of APs comprises defining one or more initial cluster centroids based on the one or more defined environmental values.

14. The non-transitory computer-readable medium of claim 9, wherein:
a first AP of the plurality of APs indicates an indoor deployment type, and
reconfiguring one or more of the plurality of APs comprises configuring the first AP as an outdoor AP.

15. A system, comprising:
one or more computer processors; and
a memory containing a program which when executed by the one or more computer processors performs an operation, the operation comprising:
receiving environmental sensor data from a plurality of access points (APs);
clustering the plurality of APs into a set of clusters based on the environmental sensor data;
generating cluster classifications by classifying each cluster in the set of clusters as either an indoor cluster or an outdoor cluster based on the environmental sensor data and one or more defined environmental values;
assigning a respective label to each respective AP in the plurality of APs based on the cluster classifications; and
reconfiguring one or more of the plurality of APs based on the assigned labels.

16. The system of claim 15, wherein clustering the plurality of APs into the set of clusters comprises:
generating a first cluster of APs and a second cluster of APs based on the environmental sensor data; and
in response to determining that a distance between the first cluster and the second cluster is below a defined threshold, merging the clusters.

17. The system of claim 16, wherein assigning a respective label to each respective AP in the plurality of APs further comprises:
determining a minimum value, maximum value, and average value of the environmental sensor data;
computing a respective score for each respective AP in the plurality of APs; and
assigning a respective label to each respective AP based at least in part on the respective score.

18. The system of claim 17, the operation further comprising in response to determining that a first score of a first AP is within a defined range:
determining a deployment type indicated by the first AP; and
assigning a respective label to the first AP based on the indicated deployment type.

19. The system of claim 15, wherein clustering the plurality of APs comprises defining one or more initial cluster centroids based on the one or more defined environmental values.

20. The system of claim 15, wherein:
a first AP of the plurality of APs indicates an indoor deployment type, and
reconfiguring one or more of the plurality of APs comprises configuring the first AP as an outdoor AP.
